(19) United States
(12) Patent Application Publication
(10) Pub. No.: US 2010/0153556 A1
(43) Pub. Date: Jun. 17, 2010

(54) Provider-Controlled Local Network Storage and Method of Use

(75) Inventor: Steven Bellovin, Westfield, NJ (US)

Correspondence Address: AT & T Legal Department - WS;Attn: Patent Docketing, Room 2A-207, One AT & T Way, Bedminster, NJ, 07921, US

(73) Assignee: AT&T INTELLECTUAL PROPERTY I, L.P., Reno, NV (US)

(21) Appl. No.: 12/336,091

(22) Filed: Dec. 16, 2008

(51) Int. Cl. G06F 15/173

(52) U.S. Cl. 709/226

(57) ABSTRACT

The present invention comprises a device and method for provider initiated transfer of data from a local network of a user, at a rate and time designated by the provider in order for a provider to balance local network traffic loads or due to another need of a service provider and allow a user to more quickly copy data to be placed at a location on a wide area network. Further, the provider may be notified when data is stored at the designated location or based on provider-initiated request for changed data. The provider may evaluate data traffic on its network to determine when and at what speed a transfer of data should be initiated from the designated location to the provider's network for storage at a second location on, for example, the wide area network.

### TITLE OF THE INVENTION

Provider-Controlled Local Network Storage and Method of Use

### BACKGROUND OF THE INVENTION

Consumer broadband links, in particular DSL, cable modems, and even consumer-grade fiber optic links, typically have asymmetric speeds. Downloading is much faster than uploading due to various technical considerations. This is acceptable for consumers browsing websites and checking e-mail, however, the slower upload speed becomes problematic when a user wishes to share a personal web page, photos, back up local drives to the internet, or make his files available when traveling.

Some of the aforementioned activities are often prohibited on consumers' computers by Internet Service Providers (“network providers” or “service providers”) because the load on the network would be too great. Cable modems often share bandwidth with neighbors and network providers may pay have to pay higher charges to transfer data at peak hours or may need to purchase higher bandwidth links to accommodate traffic at peak hours of the day. However, during the night hours data traffic across the network provider may be significantly less than the available bandwidth. Accordingly, data uploads my be more economically accomplished at times of lower bandwidth demands.

In addition to potential cost savings, other advantages accrue if data upload is delayed to a later time. For example, uploading data at a given time may degrade the quality of other services being accessed, such as video, because of bandwidth limitations on the network link to the user or an upstream network link. Uploading at later times of lower usage will not result in performance degradation.

Thus, there is an unsolved need to normalize the bandwidth on data traffic networks, such as consumer broadband links, in order to better utilize data traffic links.

### SUMMARY OF THE INVENTION

The present invention comprises a device and method for provider initiated transfer of data from a location on or accessible to a local network of a user, at a rate and/or time designated by the provider in order for a provider to balance traffic loads or another need of the provider and allow a user to more quickly copy data that is ultimately to be placed at a location on a wide area network. A device of the invention and the method of carrying out the invention may comprise storing user data at a designated location on a local network accessible to the user, the location having connectivity with the local network and with the provider. The provider may be a provider of a wide area network connectivity such as a connection to the internet. Further, the provider may be notified when data is stored at the designated location, and the provider may evaluate data traffic on its network to determine when and/or at what speed a transfer of data should be initiated from the designated location to the provider's network for storage at a second location on, for example, the wide area network.

In an embodiment of the invention, a method for transferring user data to a wide area data network comprises designating a data storage location for the user data on a local network, the data storage location at least partially controlled by a provider, notifying the provider of data in the data storage location, evaluating a characteristic of data traffic on a wide area data network of the provider, and initiating a transfer of the user data by the provider from the data storage location to the wide area data network based on the data traffic. The method may further comprise a step of provider initiated removal of user data from the data storage location and, in a farther embodiment, the data storage location may be storage space on a router.

The provider may specify a time for transferring the data to the wide area network. This transfer may be automated, such as being triggered based on data traffic on a network of said provider or another need of the provider. Further, a set amount of bandwidth may be allocated. Additionally, the user data may be transferred to a pre-designated location on the wide area network, the location designated by the user.

In an embodiment of the device of the invention for transferring user data, the device comprises network connectivity with a local network and a network provider, and a data storage apparatus at least partially controlled by the network provider. The device is configured to notify the provider of data stored on the data storage apparatus. Upon a request from the network provider, the request based at least on characteristic of traffic on a network of the provider, the device sends data on the data storage apparatus to the network provider.

The data storage apparatus may be controlled by the provider in that the provider may send a command or otherwise cause data to be removed from the data storage apparatus. The provider may remove the data after it has been sent to the network provider or the data has reached an intended destination, such as a destination chosen by a user who placed the data on the data storage apparatus. Further, the device may be a router. The request from the network provider may be a request to transfer the user data at a future time and the device may send the data at a future time.

A device for transferring user data as used in embodiments of the invention may comprise means for routing data traffic between a provider and a local network, means for storing data, means for notifying the provider of stored data, means for receiving a command from the provider to send said stored data substantially at a time specified in the command, and means for sending said stored data to the provider at the specified time. The specified time may be the time that the command is received. The command may be sent based on a need of the service provider such as bandwidth needs. The device may further comprise means for removing the stored data upon receiving a command from the provider to do so. A command to send the data may be based upon data traffic on a network of the provider and may be an instruction to use a limited amount of bandwidth, and the amount set may be based on an evaluation of data traffic on the network of the provider. The data may be transferred to a location selected by the user (i.e. the person who placed the data on the device).

### BRIEF DESCRIPTION OF THE DRAWINGS

FIG. 1 shows an illustration of a typical local network that may be used in an embodiment of the invention.

FIG. 2 shows a high level block diagram of a device that may be used to carry out the invention.

FIG. 3 shows a high level block diagram of a network form the perspective of a network provider in embodiments of the invention.

FIG. 4 shows a flow chart of a method of transferring data from a data storage location on a local network in an embodiment of the invention.

FIG. 5 shows a flow chart of a method of transferring data from a data storage location on a local network based on need in an embodiment of the invention.

FIG. 6 shows a high level block diagram of a computer that may be used to carry out the invention.

### DETAILED DESCRIPTION

The present invention comprises a device and method for provider initiated transfer of data from a location on or accessible to a local network of a user, at a rate and/or time designated by the provider in order for a provider to allow a user to more quickly copy data to be placed at a location on a wide area network while permitting the provider to balance traffic loads. A device of the invention and the method of carrying out the invention may comprise storing user data at a designated location on a local network, the location having connectivity with the local network and a provider. The provider may be a network provider of a wide area network connection, such as a connection to the internet. Further, the provider may be notified when data is stored at the designated location, and the provider may evaluate data traffic on its network to determine when and/or at what speed a transfer of data should be initiated from the designated location to the provider's network for storage at a second location on, for example, the wide area network.

Embodiments of the invention will be more clearly understood in light of the description of the figures.

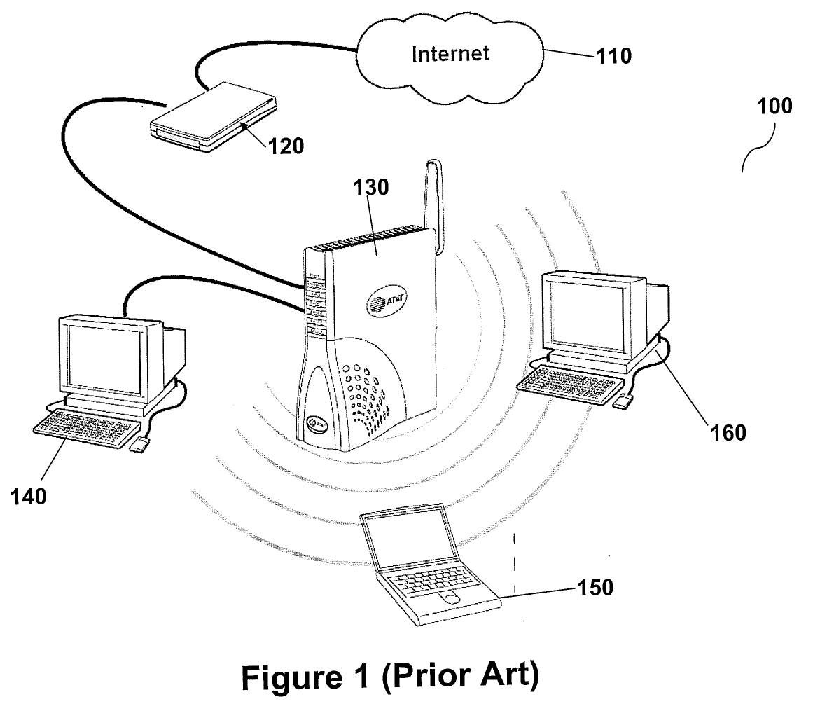

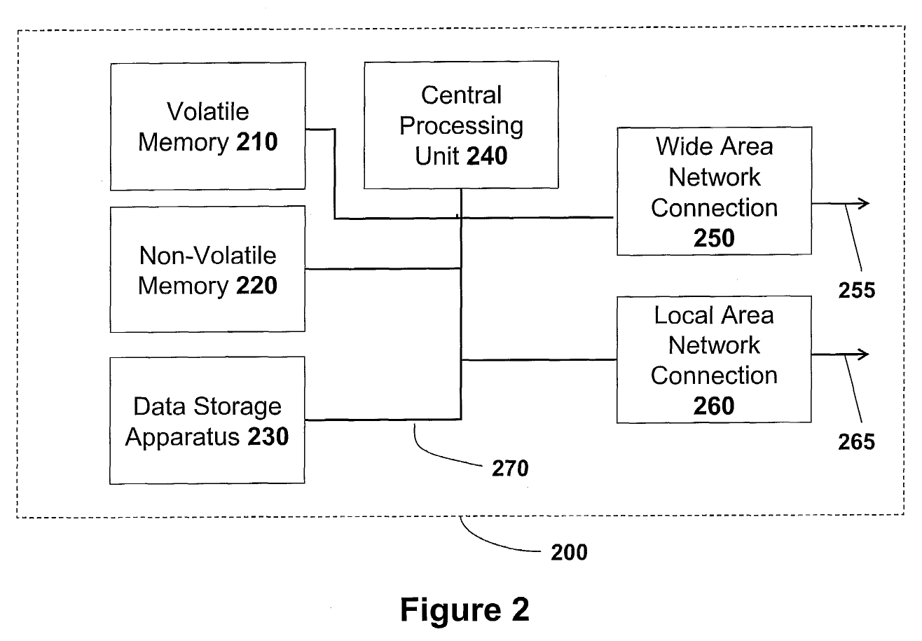

FIG. 1 shows an illustration of a typical local network that may be used in an embodiment of the invention. A local network 100 may comprise a connection to the internet 110 or a wide area network. The connection may be provided by an adapter 120, such as a DSL router, a cable modem, or the like. The adapter 120 typically is assigned an IP address on the network of a network provider (the provider of the connection to the internet 110) and receives data from the network provider. The adapter 120 is connected to a local router 130 such as a four port router broadcasting a wireless signal at 2.4 GHZ. The local router 130 typically is assigned an IP address by the adapter 120 or takes the IP address of the adapter 120 when communicating with the network provider, and assigns IP addresses to devices on the local network. Thus, the router engages in IP routing and translation of IP addresses as is generally known in the art. One or more computers 140 may be physically connected to the local router 130 such as by an Ethernet network connection or be connected via a wireless data signal, such as laptop computers 150 or desktop computers 160. Adapter 120 and local router 130 may be integrated into a single unit. In such an embodiment, the adapter / local router serves both the functions of providing network connectivity with the internet 110 and routing traffic to computers 140, 150, and/or 160. In embodiments of the invention, as shown in FIG. 2, a data storage apparatus of the invention may be located on the adapter 120, the router 130, integrated into a device comprising both the adapter 120 and router 130, or on computers 140, 150, and/or 160.

FIG. 2 shows a high level block diagram of a specific device that may be used to carry out the invention. The device of FIG. 2 may be a standalone device or comprise part of a router, an adapter, or another device capable of receiving and sending data traffic on a network. Data bus 270 carries data between elements of device 200. Volatile memory 210 stores data during operation of the device and is reset upon powering down the device 200. The volatile memory 210 may be RAM, NVRAM, or the like. Non-volatile memory 220 may be ROM and stores data such as configuration settings and instructions for operation of the device 200. The non-volatile memory 220 typically may not be written over by a user. The data storage apparatus 230 may be volatile or non-volatile memory such as a hard disk, flash memory, or optical media and is rewritable. In embodiments of the invention, the data storage apparatus appears as a local or network drive on computers 140, 150, and/or 160. A user may upload files at local network speeds (which are typically greater than wide area network speeds) to the data storage apparatus and move on to the next task. The device 200 is then configured to notify the network provider that data is on the device and the network provider will instruct the device as to when and, optionally, at what rate to send the data to the network provider. The user placing the data on the data storage apparatus, a local network administrator, or the network provider may designate a location where the data will be transferred to. The Central Processing Unit (CPU) 240 controls the flow of data and executes commands to process data in the device.

Wide Area Network Connection 250 connects the device 200 via connection means 255 (such as a copper cable, fiber cable, or a wireless transceiver) to a wide area network such as to an adapter 120 or a wide area network such as the internet 110. The Wide Area Network Connection 250 typically connects either directly or indirectly with a network provider via connection means 255. Local network Connection 260 connects the device 200 via connection means 265 (such as a copper cable, a fiber cable, or a wireless transceiver) to a local network. Connection means 255 and 265 may allow for a network connection to any one of or multiple of the devices shown in FIG. 1. In embodiments of the invention, any combination of network connections 250 and 260 may be used. For example, when the device 200 is a standalone device on a local network, a local network connection 260 may be used whereas a wide area network connection 250 may be absent. When the device 200 is part of a router or adapter, typically the device also provides network address translation and/or packet forwarding features and comprises at least one wide area network connection 250 and a plurality of local network connections 260 such as four Ethernet jacks and a wireless transceiver for wirelessly connected to devices.

The device of FIG. 2 is at least partially controlled by a provider of network connectivity such an internet service provider. Such partial control is at least the ability of the provider to direct or cause the device to send data on the data storage apparatus 230 to the provider at a time specified by the provider. The provider makes such a request based on data traffic on the provider's network which may be data traffic between the local network and the provider (such as over a data connection between adapter 120 and an internet connection 110 provided by the provider) or based on the data traffic of the provider itself. This will become clearer with reference to the following figure.

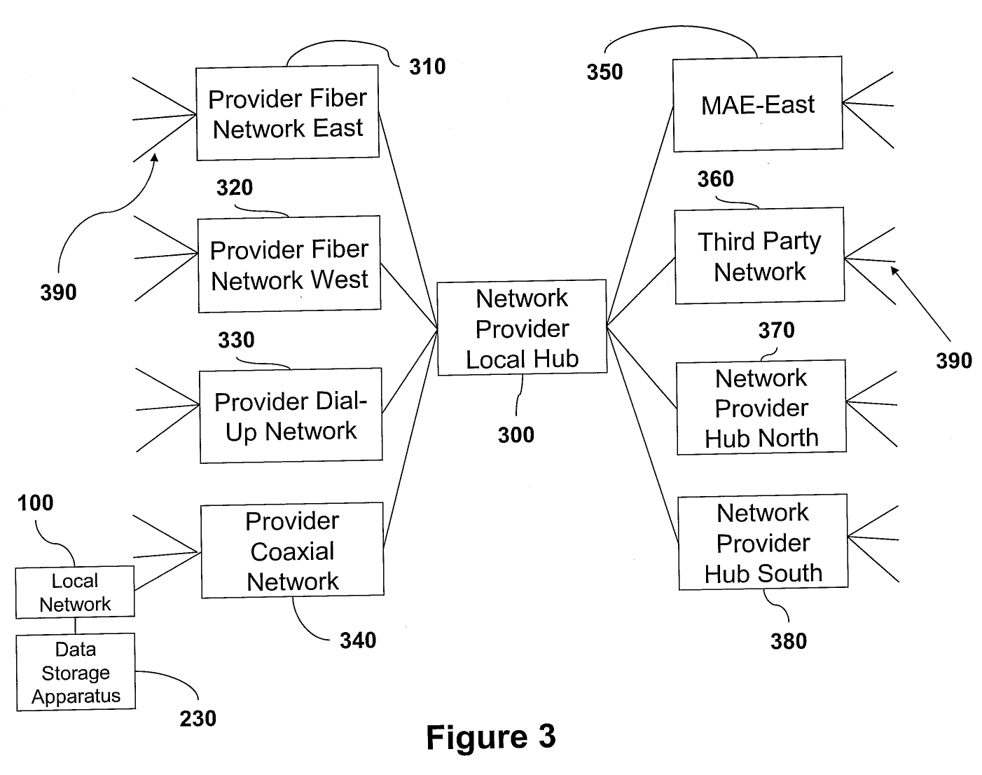

FIG. 3 shows a high level block diagram of a network from the perspective of a network provider. The figure is for illustration purposes. Substantially any network configuration may be used wherein a network provider provides network connectivity, such as an internet connection, to a location, such as to a business, end-user, or local network of a consumer. The network provider has a local hub 300 which connects to various points on a wide area network such as the internet. For example, the network provider may connect to a backbone such as MAE-East 350 providing network connectivity to many network service providers on the internet. The network provider may also connect to other third party networks 360 or other data centers or connection points operated by the network provider itself such as network provider hub north 370 or network provider hub south 380. Each of these connection points 350, 360, 370, and 380 may connect to various points on a wide area network as illustrated by connection lines 390. Further, the network provider may comprise a variety of network links for which the network provider provides network connectivity, such as an east fiber network 310, a west fiber network 320, a dial-up network 330, or a coaxial network 340. Typically, such a network provider on the internet is referred to as the internet service provider for nodes (individual local networks and computers) on networks 310, 320, 330, and 340.

By way of example of an embodiment of the invention, a data storage apparatus 230 (see FIG. 2), which is at least partially controlled by the network provider, has network connectivity provided by the network provider by way of a local network 100 (see FIG. 1). The network provider may at least partially control the data storage apparatus 230 from any node of the network of the network provider and may control the data storage apparatus based on data traffic anywhere on the network, for example, between the local network 100 and an uplink to the provider's network, between the local network 100 and the local hub 300, between the coaxial network 340 and the local hub 300, between the local hub 300 and a third party network 360, and so forth.

Considerations which may be taken into account in controlling when data is uploaded from the data storage apparatus to the network provider may include present or historically used bandwidth between nodes on the network, where the data is to uploaded to, a cost of sending data across a path on the network at a given time compared to another time, and so forth. It may be desired to control multiple data storage apparatuses 230 from a central location, such as at the local hub 300 or from a computing device connected directly or indirectly to the local hub 300. This may be desired in order to normalize traffic across the network as a whole or individual segments of the network to coordinate uploads so as not to overburden the network at one time. The data storage apparatus may be configured to send data immediately upon notification of such to the network provider (such as by beginning to send data) or at a later time designated by the network provider by way of a command from the network provider to the device 200. The network provider may also issue a command sent over the network to the device 200 to delete or erase data on the data storage apparatus 230 upon successful upload. A user may be notified of a successful upload via e-mail, instant message, or other means known in the art.

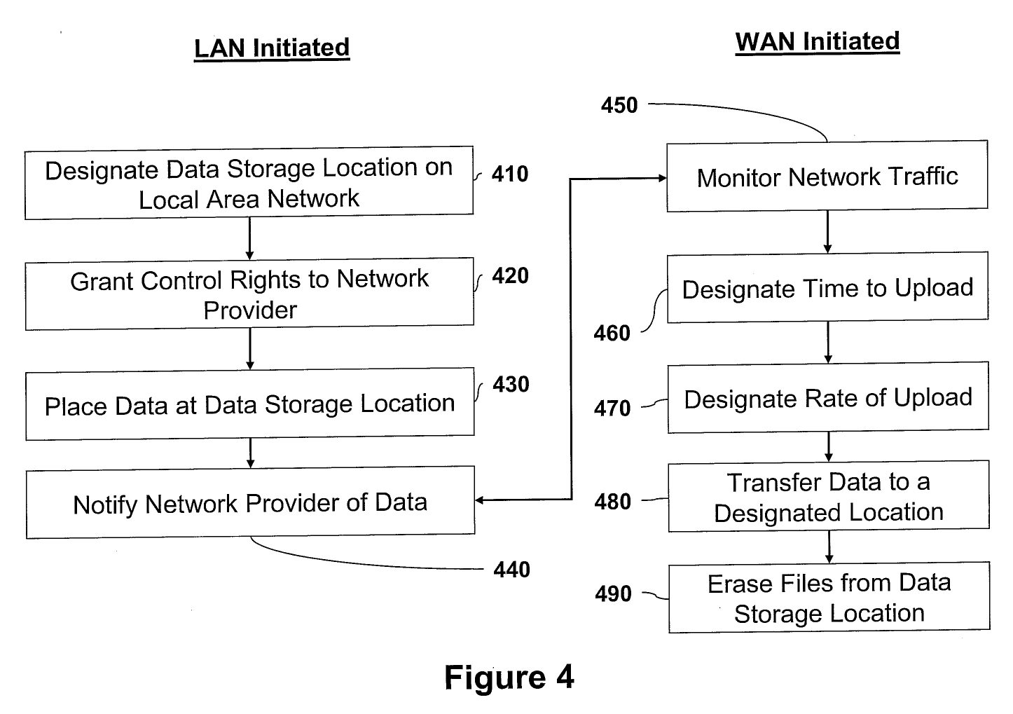

FIG. 4 shows a flow chart of a method of transferring data from a data storage location on a local network in an embodiment of the invention. Steps 410-440 are typically initiated at or on the Local network, i.e. the network of an end-user or consumer), except where indicated otherwise. Steps 450-480 are typically initiated at or on the Wide Area Network (WAN, i.e. the network of a network provider), except where indicated otherwise. In step 410, a data storage location is designated on the local network. This may be on a data storage apparatus 230 (see FIG. 2) and/or a data storage location on a networked computer, router, internet adapter, or the like. The data storage location may be a location which appears as a network drive on a local computer using protocols known in the art for networking data storage locations.

In step 420 the network provider (provider of the WAN connection) is given some control rights to the data storage location. This may be part of an automated process whereby upon installation of a device or software configured to carry out instructions to perform the steps of the invention, a network provider is contacted and granted rights. The rights may be the ability to directly or indirectly cause a data storage apparatus 230 or other data storage location to send data to the network of the provider and to erase data from the data storage location. The rights may also include setting a maximum speed and a time for sending the data. In the method of the invention, the data may remain on the data storage location and the remote location, such as a web folder on the internet, may be synchronized with the local folder. In this manner, a user may achieve quicker upload speeds of his data and the data may be synchronized when traffic on the network provider's network or anywhere between the web folder or other final destination and the local user is lower.

In step 430, data is placed at the data storage location, and in step 440, the network provider is notified of the placed data. The network provider may be notified upon placement of data at the data storage local in step 430 or the network provider may be notified upon the data storage device being polled directly or indirectly to determine if new data has been placed at the data storage location. Such polling may take place at regular intervals, at times when data traffic may optimally be transferred from the local network to the WAN or final destination of the data, or upon a request for the data by another. For example, if the data is to an online backup site, the network provider may poll a data storage apparatus 230 every night (when traffic is low) to determine if new data should be uploaded to the offline backup site. Or, if a file is requested from a web server, the network provider may initiate a request carried over the local network to determine if new data is waiting on the data storage apparatus 230 (or other data storage location) to be sent.

In step 450, network traffic is monitored. This may be traffic between the local network and the network provider, traffic on a segment between the local network and the network provider, traffic between the network provider and the destination for the data presently at the data storage location, or any combination thereof or as described with reference to FIG. 3. This step may take place concurrently with or only after step 440, may take place before step 440 (such as recordation of historical traffic data), may take place during the transfer of data from the data storage location, or any combination thereof.

The monitoring in step 450 may be for purposes of determining a need of the service provider. For example, the service provider may have increased traffic due to a large number of users taking part in online video sharing or a large number of voice over IP (internet protocol) phone calls. In such cases, quality of service issues may be present and transferring data from the data storage location would cause too many packet collisions even if there is enough bandwidth. In other cases, there simply may not be enough bandwidth. In still further cases, the service provider may desire to do maintenance on the network at a certain time and desires to have as little traffic travelling over the network at a certain time. In still other cases, the service provider may decide to have as much traffic over the network as possible due to cheaper rates at a certain time, fault testing of equipment, or other reasons. In short, embodiments of the disclosed technology allow the service provider to have some control over when traffic from it's users is transferred over it's network.

Based on the monitored network traffic and data to be transferred form the data storage location, in step 460 a time is designated to upload the data to the network provider. The data may also be transferred to a destination location such as a web folder or third party location. A rate of speed, in step 470, may also be designated. The rate of speed may be the maximum throughput available or may be a subset thereof. The rate of speed may change over time. For example, if step 440 takes place during peak hours, it may be desired to designate a low rate of upload (i.e. 685 kb/sec) and if the transfer continues until after the peak hours have completed and data traffic has decreased, a higher rate of upload may be used (i.e. 5280 kb/sec), by way of example.

In step 480, upon setting the time, and optionally, the rate conditions, the data is transferred from the data storage location on to the network of the network provider and to a designated location on the network of the provider or at any other location on the network such as a web server or third party connected to the internet. In step 490, the files on the data storage location may optionally be erased. For example, upon completion of a transfer of data from the data storage location to a destination (the destination being set by the consumer, the network provider, or a third party), the data may be removed from the data storage location.

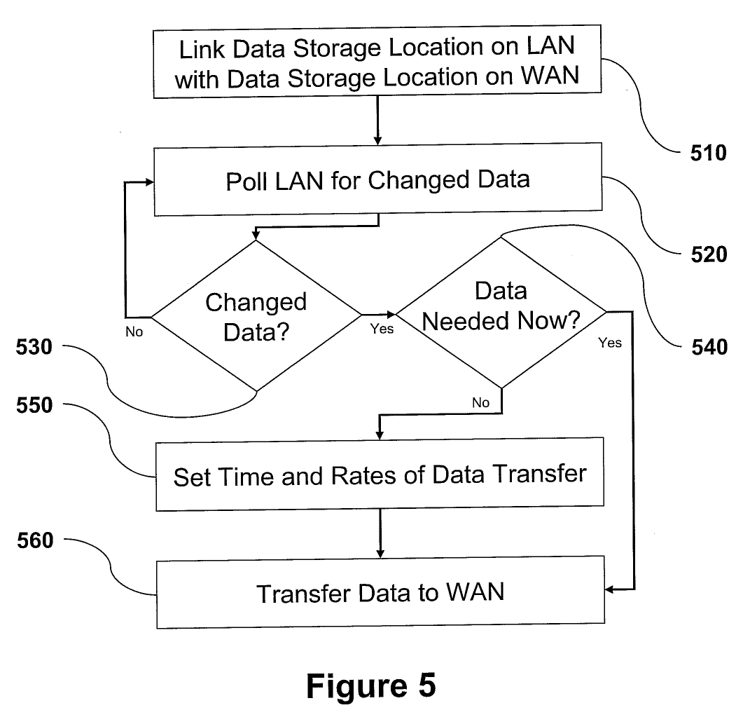

FIG. 5 shows a flow chart of a method of transferring data from a data storage location on a local network based on need in an embodiment of the invention. In step 510, a data storage location on the local network, such as on a data storage apparatus 230 or other data storage locations as described with reference to FIG. 4 is linked to a data storage location on the wide area network such as designated location as described with reference to at least step 480 of FIG. 4. Thus, data on the data storage location of a consumer or end-user is synchronized with a web folder or other designated location for the data to be transferred to. In step 520, data is sent across the local network to poll the data storage location so that a data storage apparatus or a computing device on the local network can notify the provider of changed data. Such polling may additionally take place if there is a trigger event such as a request for the data from the data storage location on the WAN (for example, a webpage, offsite backup, and the like), a set amount of time has elapsed, or data traffic is low on the provider's network providing an optimal time to begin a transfer of data. Alternatively or in addition, upon changing the data at the data storage location, the provider may be notified or a notification may be sent across the provider's network of the change in data.

After polling the local network or sending a request through the local network, in step 430, if there is no changed data at the data storage location on the local network or it is determined that the data is the same as the data on the WAN data storage location, then step 520 is repeated, typically, after a delay or a trigger event as described above. However, if the data has changed (i.e. the data is not synchronized), then, in step 540, a determination is made as to whether the data is needed now.

The data may be needed now when the trigger event was caused by a request for data existing on the data storage location of the local network but was not found on the data storage location of the WAN. In such an embodiment, the data storage locations are treated as one location from the perspective of a third party attempting to access the data, such as a person viewing a webpage or attempting to download a file from a file server on the internet. In such an embodiment, a request may first be made to the data storage location on the WAN for the data, and if not found, step 520 is carried out wherein a request sent across the local network is made to receive the data. In such a case, step 560 is carried out immediately and the data is transferred to the data storage location of the WAN and then to the third party requesting the data. Alternatively, step 440 may be carried out and the time set for the data transfer is immediate and the rate set is the maximum throughput available. If the data is not needed now, such as when data is sent across the local network to determine if data is changed at a periodic interval, then a later time or slower rate may be set before carrying out step 560 whereby the changed data is transferred on to the WAN on the way to the data storage location on the WAN which may be any location on a network such as the internet.

For example, a photo library of a user may be publicly accessible such as on a website or platform that allows photo sharing. A user may designate the place where the data will be transferred to, such as to the photo sharing platform. When another person or entity requests a photo (i.e. a data file with data representing or viewable as an image), if it has not been uploaded from the local network, then it will be uploaded upon this request for the data.

Still further, in the embodiment of FIG. 5, the network provider may have access to erase data from the data storage location on the local network. Erasing data may take place, when, for example, synchronization occurs in the reverse direction than as described above meaning that the data storage location on the WAN is the source of data and data on the local network is meant to be a backup or second copy. Still further, in another embodiment of the invention, synchronization is bi-directional, meaning that data on both locations is meant to be a copy of the other. If data is deleted or added to the data storage location on either the local network or WAN, such will take place at the respective other location.

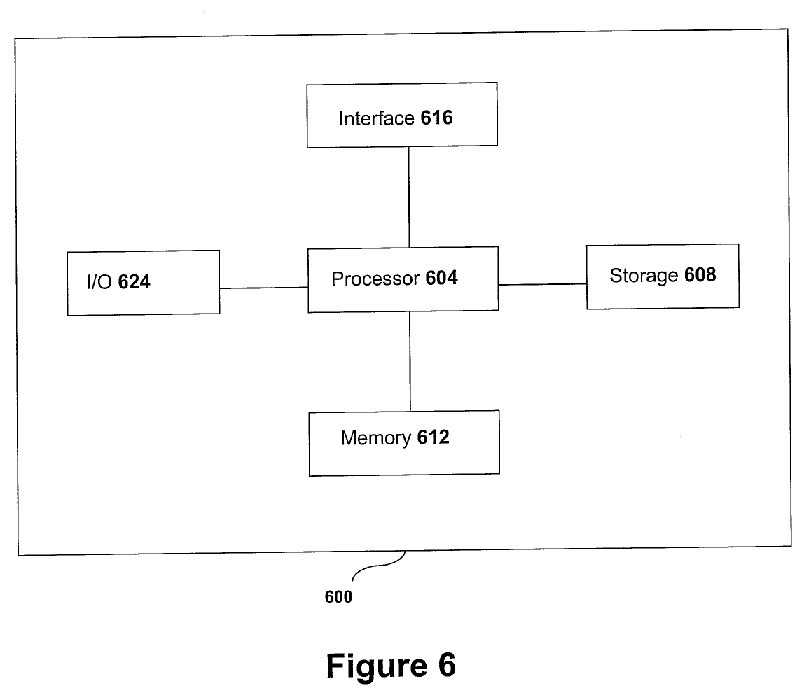

FIG. 6 shows a high-level block diagram of a computer that may be used to carry out the invention. Computer 600 contains a processor 604 that controls the overall operation of the computer by executing computer program instructions which define such operation. The computer program instructions may be stored in a storage device 608 (e.g., magnetic disk, database) and loaded into memory 612 when execution of the computer program instructions is desired. Thus, the computer operation will be defined by computer program instructions stored in memory 612 and/or storage 608, and the computer will be controlled by processor 604 executing the computer program instructions. Such instruction may, for example, implement the methods of FIGS. 4 and 5. Computer 600 also includes one or a plurality of input network interfaces for communicating with other devices via a network (e.g., the Internet). Computer 600 also includes one or more output network interfaces 616 for communicating with other devices. Computer 600 also includes input/output 624 representing devices which allow for user interaction with the computer 600 (e.g., display, keyboard, mouse, speakers, buttons, etc.). One skilled in the art will recognize that an implementation of an actual computer will contain other components as well, and that FIG. 6 is a high level representation of some of the components of such a computer for illustrative purposes. It should also be understood by one skilled in the art that the method and devices depicted in FIGS. 1 through 6 may be implemented on a device such as is shown in FIG. 7.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for managing user data comprising:
designating, on a local network accessible by a user, a data storage location for storage of user data, said data storage at least partially controlled by a service provider; and
initiating, based on a need of said provider, a transfer of said user data by said provider from said data storage location to said data network.

2. The method of claim 1, further comprising removing said user data from said data storage location.

3. The method of claim 1, wherein said data storage location is on a router.

4. The method of claim 1, wherein said step of initiating is at a time specified by said provider.

5. The method of claim 4, wherein said step of initiating is based on volume of data traffic on said data network of said provider.

6. The method of claim 5, wherein bandwidth is allocated on said data network of said provider to accomplish said transfer of said user data.

7. The method of claim 5, wherein said data storage location is pre-designated by said user.

8. The method of claim 1, wherein a destination of said data is pre-designated by said user.

9. The method of claim 1, wherein said need is based on a characteristic of data traffic on a data network of said provider.

10. An apparatus comprising:
means for designating, on a local network accessible by a user, a data storage location for storage of user data, said data storage at least partially controlled by a service provider; and
means for initiating, based on a need of said provider, a transfer of said user data by said provider from said data storage location to said data network.

11. The apparatus of claim 10, wherein said transfer comprises removal of data on said data storage apparatus.

12. The apparatus of claim 11, wherein said data is removed after said data is sent to said network provider.

13. The apparatus of claim 11, wherein said need is based on a characteristic of data traffic on a data network of said provider.

14. A computer readable storage medium comprising instructions for execution on a computer, said instructions comprising:
designating, on a local network accessible by a user, a data storage location for storage of user data, said data storage at least partially controlled by a service provider; and
initiating, based on a need of said provider, a transfer of said user data by said provider from said data storage location to said data network.

15. The medium of claim 14, further comprising instruction for removing said user data from said data storage location.

16. The medium of claim 14 wherein said data storage location is on a router.

17. The medium of claim 14, wherein said step of initiating is at a time specified by said provider.

18. The medium of claim 17, wherein said step of initiating is based on volume of data traffic on said data network of said provider.

19. The medium of claim 18, wherein bandwidth is allocated on said data network of said provider to accomplish said transfer of said user data.

20. The method of claim 14, wherein said data storage location is pre-designated by said user.

21. The medium of claim 14, wherein a destination of said data is pre-designated by said user.

22. The medium of claim 14, wherein said need is based on a characteristic of data traffic on a data network of said provider.
